(19) United States
(12) Patent Application Publication
(10) Pub. No.: US 2015/0113074 A1
(43) Pub. Date: Apr. 23, 2015

(54) SYSTEM AND METHOD FOR SOCIAL INTRODUCTIONS

(71) Applicant: Forever Ventures, LLC, Richardson, TX (US)

(72) Inventor: Brian I. Marcus, Mill Valley, CA (US)

(73) Assignee: Forever Ventures, LLC, Richardson, TX (US)

(21) Appl. No.: 14/056,822

(22) Filed: Oct. 17, 2013

(51) Int. Cl. H04L 12/58

(52) U.S. Cl. CPC H04L 51/32
USPC 709/206

(57) ABSTRACT

A system and method are disclosed enabling users to identify and discreetly contact other users at a venue via their computing devices. In an example, a map of the venue may be displayed to users on their computing devices, together with representations of the positions of users in the venue. A first user may select the representation of a second user on his or her computing device, and thereafter see information about the second user and/or send a message to the second user.

### BACKGROUND OF THE INVENTION

People often attend social gatherings with the hope of meeting new people and making new friends. However, making an initial introduction can be intimidating and many social interactions to meet new people and friends may never take place. Moreover, at a venue, there may be people who are interested in meeting others, and people who are simply there to have an enjoyable time with their friends and would prefer not interact with new people. It would be helpful if there was a system for discerning between these two groups of people.

### DESCRIPTION OF THE DRAWINGS

FIG. 1 is a block diagram of a network topology for implementing embodiments of the present technology.

FIG. 2 is a block diagram of a service for implementing aspects of the present technology.

FIG. 3 is an example of a venue including patrons and support staff, and sensors for implementing aspects of the present technology.

FIG. 4 is a flowchart for venues to subscribe to the service of the present technology.

FIG. 5 is a flowchart for users to subscribe to the service of the present technology.

FIG. 6 is illustration of a display of a computing device for a user to subscribe to the service of the present technology.

FIG. 7 is a flowchart illustrating operation of an embodiment of the present technology.

FIG. 8 is an illustration of a display of a computing device of a user showing a map of a venue and the location of other users at the venue.

FIG. 9 is a top view illustration of a venue including sensors locating a position of a computing device or user.

FIG. 10 is a top view illustration of a venue including sensors locating a position of a computing device according to an alternative embodiment.

FIG. 11 is a top view illustration of a venue including a sensor locating a position of a computing device according to a further alternative embodiment.

FIG. 12 is an illustration of a display of a computing device showing an enlarged view of a section of a map of the venue and location of users within that section of the map.

FIG. 13 is an illustration of a display of a computing device showing an enlarged view of a section of a map of the venue and a real time, updated location of users within that section of the map.

FIG. 14 is an illustration of a display of a computing device showing a profile of a second user which has been selected by a first user.

FIG. 15 is an illustration of a display of a computing device showing a text message received by a second user from the first user, and soft buttons providing the second user with options for response.

FIG. 16 is an illustration of a display of a computing device showing a location of the first user to the second user.

FIG. 17 is an illustration of a display of a computing device showing a text message response from the second user to the first user.

FIG. 18 is an illustration of a display of a computing device showing text messages according to an alternative use scenario of the present technology.

FIG. 19 is an illustration of a display of a computing device showing text messages according to a further alternative use scenario of the present technology.

FIG. 20 is an illustration of a display of a computing device showing a text message according to a further alternative use scenario of the present technology.

FIG. 21 is an illustration of a display of a computing device showing a map of an outdoor venue and positions of users at the venue.

FIG. 22 is an illustration of a display of a computing device including the positions of users with no map.

FIG. 23 is block diagram of a sample computing device for implementing embodiments of the present technology.

### DETAILED DESCRIPTION

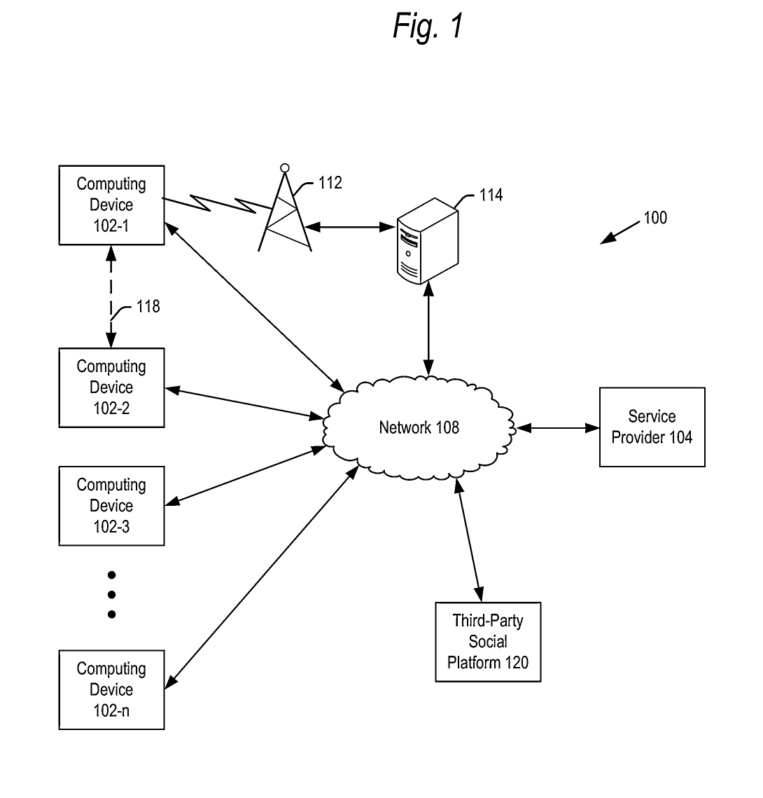

Embodiments will now be described with reference to FIGS. 1 through 23, which in general relate to a system and method for discreet social introductions at or involving a venue. It is understood that the present technology may be embodied in many different forms and should not be construed as being limited to the embodiments set forth herein. Rather, these embodiments are provided so that this disclosure will be thorough and complete and will fully convey the invention to those skilled in the art. Indeed, the present system is intended to cover alternatives, modifications and equivalents of these embodiments, which are included within the scope and spirit of the present system as defined by the appended claims.

In general, the present technology allows two (or more) people who have no prior knowledge each other, or contact information for each other, to send private and discreet communications to each other via their computing devices such as their mobile phones. In one example, the present technology allows a first user to view the location of other users at a venue on a map displayed on the first user's computing device. Users' positions are displayed on the map and updated in real time as users move around the venue. When the first user wishes to introduce him or herself to a second user, the first user locates the second user on the map. Various tools may be provided to allow the first user to correlate the second user in real world space with the correct indication of the second user on the displayed map.

Positions of users in the real world space may be indicated by location tags that are displayed on the map. Once the first user has identified the second user on the map (by locating the second user's location tag), the user may select the location tag for the second user on the map. When the second user subscribed to the service, the second user may have provided a mobile telephone number for receiving text messages. Once the first user selects the second user's location tag, the system may open a messaging software application on the first user's device with a text message addressed to the second user's mobile telephone number. The first user may then send a text message to the second user to introduce him or herself and start a dialog. Thus, embodiments enable a first user to discreetly contact one or more second users, for example using a cellular phone or other computing device, without knowing beforehand any contact information for the one or more second users.

Once the second user receives the text message, the second user is provided with a few options. The second user may respond to the first user. The second user may look at the first user's profile. The second user may find the first user on the map of his/her computing device, so as to identify the position of the first user in real world space. The second user may view subscribing friends that the first and second users share in common. Or the second user may block incoming texts from the first user. Other use scenarios are contemplated.

FIG. 1 shows a block diagram of a sample network topology 100 for implementing embodiments of the present technology. Network topology 100 includes a plurality of computing devices 102-1, 102-2, 102-3, . . . , 102-n (referred to at times below as computing devices 102) capable of connecting to a service provider 104 via a network 108. The computing devices 102 may be any of a variety of computing devices, including for example a desktop computer, gaming console, laptop computer, tablet, personal digital assistant (PDA), mobile telephone, automobiles, cameras and smart appliances (including for example an electronic cash register at a bar, restaurant or other venue). Other computing devices are contemplated.

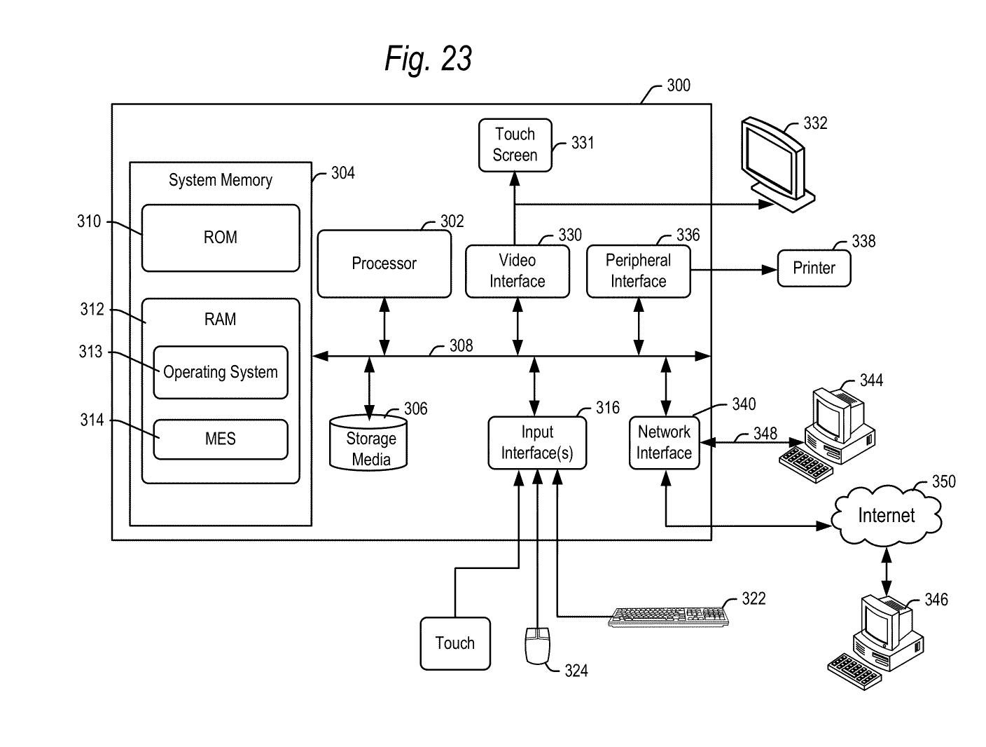

Some of the computing devices 102 may be operated by administrators (or others) associated with a venue. These computing devices may be used to set up and run the services of the present technology that are to be provided at the venue. The venue computing devices may be stationary (such as a desktop computer) or mobile (such as a laptop or tablet). Others of the computing devices 102 may be operated by end users (referred to herein as a “user” or “users”) that use the service to gain introductions to other users at a venue. These users may have computing devices 102 that are mobile (such as a laptop computer, tablet, PDA or mobile telephone). Users may also use computing devices 102 that are stationary in embodiments. Further details of a given computing device 102 are described below with respect to FIG. 23.

Where a computing device 102 is a mobile telephone (such as computing device 102-1), the computing device 102 may connect to the service provider 104 via a broadband mobile communications network. In examples, such the broadband mobile network may include base stations 112 (one of which is shown) for transferring data and software between mobile telephone 102-1 and a mobile network backbone 114. Backbone 114 may in turn have a network connection to network 108.

In embodiments, the network 108 may comprise the Internet, though other networks including, but not limited to, a LAN or WAN are contemplated. Computing devices 102 may be connected to each other by peer-to-peer connections 118 in addition to, or instead of, their connection to network 108, as indicated by dashed lines 118. Although only one connection 118 is shown, each computing device 102 may be connected to each other computing device 102 via a peer-to-peer connection 118. Other topologies 100 are contemplated.

As explained below, when subscribing to the service provider 104, users may create a social profile that is used by the service. Users may create that social profile for the service. Alternatively, users may already have a social profile that they have created and stored with a third-party social platform 120. Third-party social platform 120 may be social media websites such as Facebook®, Twitter®, etc. Alternatively or additionally, third-party social platform 120 may be dating websites such as Match.com®, eHarmony®, PlentyOfFish®, Zoosk®, Singlesnet®, etc. In embodiments, users may link or incorporate their profiles from the third-party social platform 120 to the service provider 104 for use as their profiles for the service provider 104. While one such third-party social platform is shown, there may be many that a user uses in conjunction with the present technology.

In embodiments, the venues may use computing devices 102 to connect with the service provider 104 to set up the service of the present technology within their venues. The service provider 104 may be remote from a venue, but in alternative embodiments, the service provider 104 may be resident within or integrated as part of one or more of the venues, and administered by the one or more venues. In such embodiments, an administrator (or other) associated with the venue may set up and run the service provider 104 within the venue to provide the features of the present technology within that venue. In this embodiment, multiple venues may each set up and run their own service provider 104.

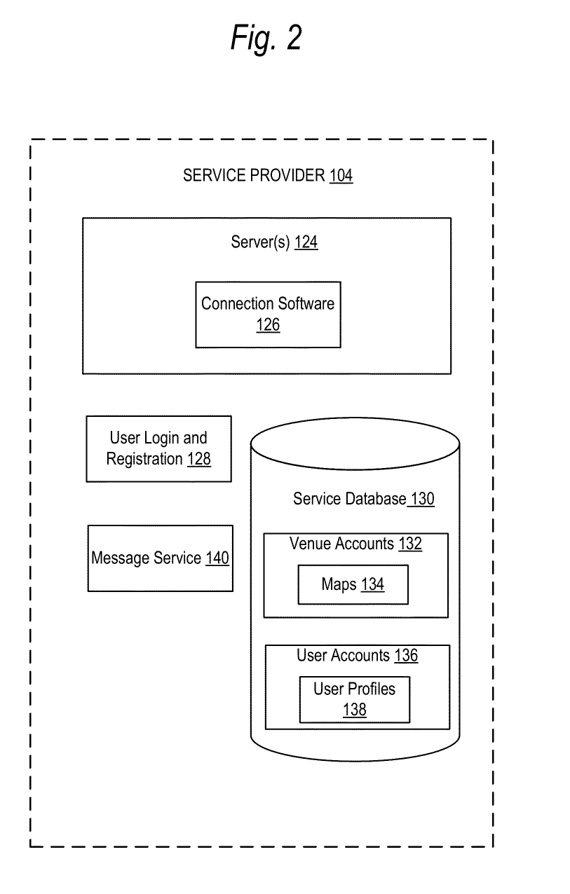

Referring now to FIG. 2, the service provider 104 may provide a collection of services which computing devices 102 may invoke and utilize. In embodiments, the service provider 104 may be an entity, brick and mortar or virtual, which provides administrative services and support services with respect to the system of the present technology to users and venues. The service 104 may additionally or alternatively act as a central repository for the storage of data and software. For example, venue maps and user profile data may be stored with the service provider 104. Additionally, a software platform, referred to herein as the connection software platform, may be run from the service provider 104. Alternatively or additionally, portions of the connections software platform may be downloaded from service provider 104 to client devices 102 and run on the client devices 102.

The service provider 104 may host one or more servers 124, which may for example include a web server, a media server for organizing and distributing selected media, and/or an ftp server supporting file transfer and/or other types of servers. One or more of these servers may be omitted in further embodiments. Servers 124 may also run or download the connection software platform 126. As explained below, the connection software platform (or just connection software) 126 may allow users to selectively locate another user at a venue, and then to privately and discreetly contact that other user. The different functions of servers 124 may be supported on different servers or otherwise combined in further embodiments. Further details of a given server 124 are described below with respect to FIG. 23.

Computing devices 102 may invoke a user login and registration service 128, which is used to subscribe and thereafter authenticate a user on a device 102 with the service provider 104. During login, login service 128 obtains an alias (or other identifier associated with the user) and a password from the user. In order to gain access to the services on service provider 104, the alias and password may be authenticated by comparing the entered credentials to venue accounts 132 or user accounts 136 in a database 130. Database 130 may be located on the same server as user login service 128 or may be distributed on a different server or a collection of different servers. User login and registration service 128 may be omitted in further embodiments. In such embodiments, any user may connect to the service provider 104 and use the connection software without having to be authenticated.

The service database 130 may include venue accounts 132 and user accounts 136. Venue accounts 132 may include login and registration information for venues that make use of service provider 104 and the services according to the present technology. As explained below, a venue may for example be a restaurant, bar or other establishment where users of the service according to the present technology may gather. Using a computing device 102, a venue may subscribe to the service by creating an account with the service provider 104 which is saved within the service database 130. In addition to account information, venue accounts 132 may include maps 134 showing one or more views of a given venue. Maps 134 are explained in greater detail below, but in general may be a top view showing the positions of walls and fixtures within a venue. The maps 134 may be created by the venue or other at the venue's request, and then uploaded to service provider 104 and saved in venue accounts 132.

User accounts 136 may include login and registration information for users that make use of service provider 104 and the services according to the present technology. User accounts 136 may further include user profiles 138, either created by a user when subscribing to the service according to the present technology, or imported from (or linked to) a third-party social platform 120 (FIG. 1). User accounts 136 may further include contact information for users such as mobile telephone numbers, email address or other contact information. Further details of setting up the login, registration and user profile are explained below. As explained below, in alternative embodiments, a user may simply connect to the service provider 104, and use the services of the present technology to locate others at a venue, without subscribing or providing profile information.

User accounts 136 may further include a friends list, which may be a list of people a user has indicated him or herself to be friendly with or otherwise associated with. In embodiments, a user's friends list may be imported from (or linked to) a third-party social platform 120. The friends list of different users may be cross-referenced in service database 130 to identify one or more friends that two or more users may share in common. In embodiments, at least portions of venue accounts 132 and/or user accounts 136 to be stored locally on a computing device 102 operated by a user, or administrator (or other) at a venue.

Service provider 104 may further include a mail message service 140 which permits computing devices 102 to send mail messages to each other. Mail messages may be sent using short message service (SMS) protocols, but other protocols may be used including without limitation multimedia service (MMS), instant messaging (IM) and email protocols. Message service 140 may permit mail messages to be sent to one or more computing devices 102 from the service provider 104, from a venue, or from another user. The mail messages may be sent via the network 108 and the broadband communications system including base stations 112 and backbone 114. In further embodiments, mail messages may be sent between computing devices 102 using only the broadband communications system (omitting service provider 104 from the loop). In still further embodiments, mail messages can be sent directly between computing devices 102 using peer-to-peer networks 118 which may be established between computing devices 102. Mail messages may be sent and exchanged between computing devices 102 using a variety of other technologies in further embodiments.

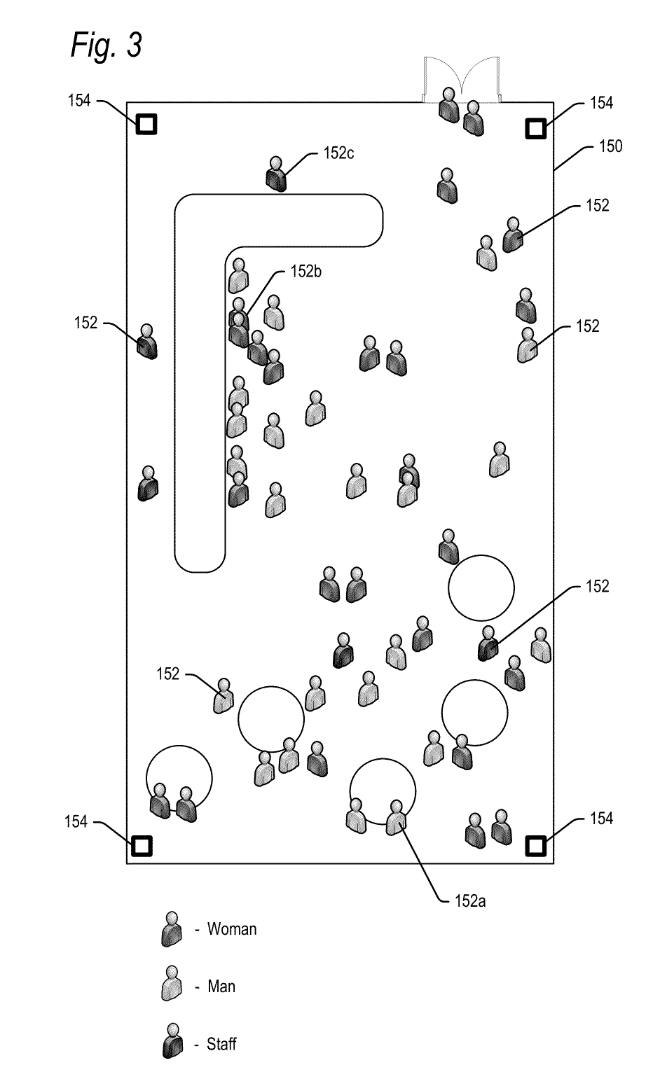

FIG. 3 illustrates an example of a venue 150 including a plurality of users 152 (only some of which are referenced in FIG. 3). In this example, the venue 150 may be a restaurant, bar or lounge. The layout is by way of example only, and will vary from venue to venue. It is also understood that venue 150 may be a wide variety of other establishments and locales, both indoor and outdoor. In general, a venue 150 may be a place where people gather together, possibly for a social function, or otherwise happen to be together. Some other examples of a venue 150 may include the location of a party (hosted at a commercial establishment or a person's home), schools, campuses, libraries, stores, offices, airports and other transportation terminals, airplanes, trains, boats, parks, amphitheaters and stadiums. Other venues 150 are contemplated. In the example shown in FIG. 3, women are indicated with a graphical icon having a first color, men are indicated with a graphical icon having a second color, and venue staff (men or women) are indicated with a graphical icon having a third color. It may be otherwise in further embodiments.

In embodiments, a venue 150 may be a place that is susceptible to mapping. That is, a venue 150 may be a place having defined boundaries (such as walls) and/or fixtures, which can be rendered on a map of the venue 150. Where a venue has been mapped, it is contemplated that the boundaries and/or fixtures may move, at which point an administrator (or another) associated with the venue may upload a layout of the venue as modified.

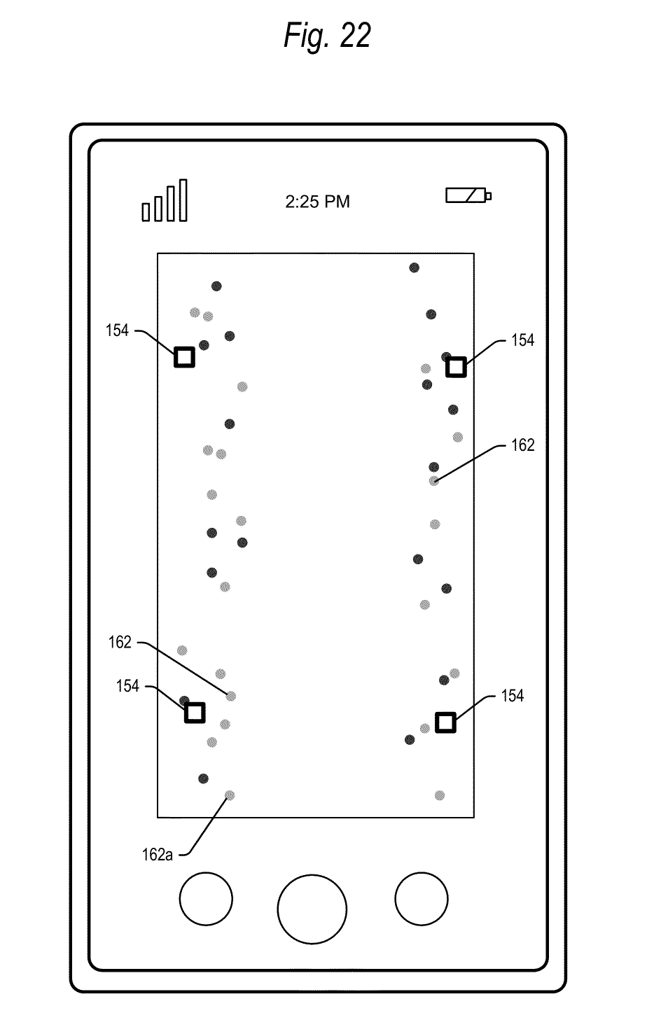

In further embodiments, a venue need not be susceptible to mapping. For example, a venue may be a large outdoor or indoor space or street either having no discernible boundaries, or boundaries which are spaced apart to the point of providing little guidance when attempting to correlate the position of people within the venue to its boundaries. This embodiment where a venue may have no boundaries is explained in greater detail below with respect to FIG. 22.

The venue 150 shown in FIG. 3 has a generally rectangular shape. However, it is understood that a venue 150 may have a wide variety of symmetrical, asymmetrical, convoluted and other shapes in further embodiments. As explained below, a venue 150 may be outfitted with sensors 154 which serve to track and identify the location of users 152 within the venue. In embodiments, the venue includes a sufficient number of sensors so as to detect and locate the positions of all users 152 in the venue, regardless of its shape. In further embodiments, a venue may have sensors that detect and locate the positions of users in some areas of the venue. Furthermore, some sensors 154 can operate through walls and a single sensor may be used for the venue regardless of its shape.

As explained below, sensors 154 may operate according to a variety of technologies. However, in one example, sensors 154 may be line of sight infrared (IR) sensors which may identify a particular user 152 (and in particular the mobile computing device 102 carried by that particular user 152) by triangulation. In such embodiments, the venue 150 may be outfitted with a number of sensors 154 so that each location in the venue 150 which may have users is visible to at least two sensors. As explained below, sensors 154 need not be line of sight sensors and each location in a venue 150 need not be visible to at least two sensors.

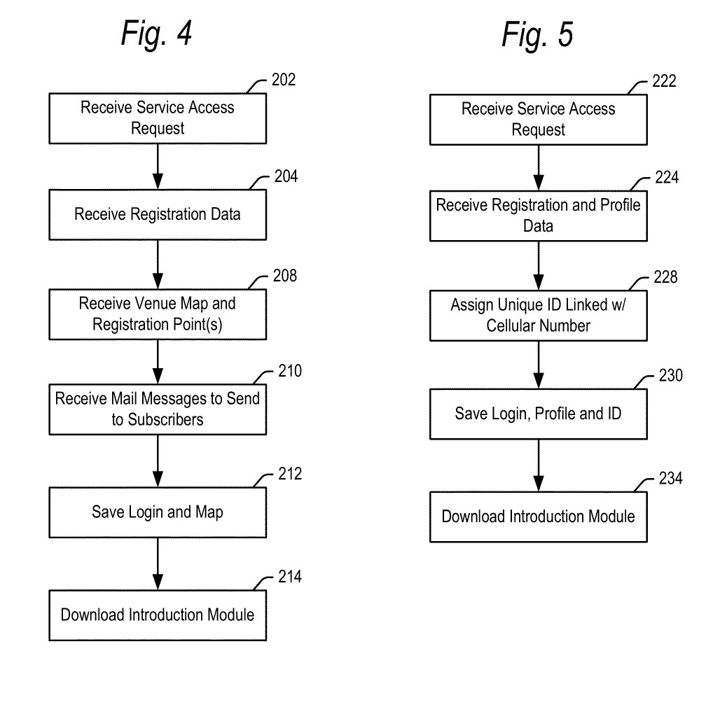

FIG. 4 is a flowchart describing steps in an embodiment whereby a venue may subscribe to the service of the present technology to allow users to locate and contact each other at the venue. In order to subscribe, an administrator (or other) associated with a venue may use a computing device 102 to contact the service provider 104 with a service access request which is received by the service provider 104 in step 202. In embodiments, this access request may be made using a web browser to access a webserver of the service provider 104. Upon prompting from the service provider 104, a user may provide registration information, which is received at the service provider 104 in step 204. This information may include an ID and password for the venue, as well as a name of the venue.

In step 208, the venue may upload a map of the venue to service provider 104. As explained below, when users use the service of the present technology at that venue, a user may access and view the map of that venue on his or her computing device 102. The map is displayed together with location tags, one for each subscribing user. The location tags on the map represent the real time positions of subscribing users in the venue.

The map may be any of a variety of renderings of the venue including for example computer-generated drawings, line drawings, blueprints, color renderings, photographs, etc. Where computer-generated, the map may be uploaded as a digital file and stored in venue accounts 132. Where not computer-generated, the rendered map may first be digitally encoded and then uploaded. In embodiments, the map may be a top view looking down on the floor of the venue. In further embodiments, side views (parallel to the floor) may alternatively or additionally be provided. Where a venue has multiple rooms on a single level, these rooms may be shown on a single map, or on multiple maps that are uploaded. Venues may also have more than one floor or level. A different map may be provided for each floor or level (where there are different levels that do not overlap, such as in a stadium, a single map or multiple maps may be provided). As explained below, the present technology may be used to identify and contact others at venues which are not mapped. For these embodiments, no map is uploaded and step 208 may be skipped.

The map may be registered to the real world space shown in the map using the known location of the sensors, or some other registration point or points. These registration point or points may also be uploaded in step 208 so that the location tags (described below) displayed on the map may accurately reflect the positions of the users in the venue. That is, one or more points on the map may be correlated to the corresponding positions of one or more users in the real world space of the venue. Using these registration point or points, the map may be registered to the reference frame of the real world space. Once the map is registered to the real world space, the positions of the location tags on the map may be displayed as an accurate reflection of the positions of the users in the real world space. Thus, for example, where a user is in the middle of a room in the real world space, the location tag for that user may be displayed in the middle of the same room on the map.

It is conceivable that the map may be registered to the real world space of the venue by methods other than registration point(s) in further embodiments. In one further embodiment, optical sensors, such as sensors 154 or other sensors, may be able to correlate real world walls and/or fixtures with walls or fixtures shown on the map. In such embodiments, no predefined registration points need be uploaded with the map.

Referring again to the flowchart of FIG. 4, a venue may choose to upload messages that are to be sent to subscribing users via the message service 140 of service provider 104. For example, the venue may upload advertisements for discounts, specials, events or a variety of other messages. The venue may also define a frequency and a maximum number of times the same message is sent to a given user. These messages may be received in the service provider 104 in step 210. The venue may upload messages in step 210 when they subscribe, and thereafter as well.

Once a venue has provided login and other information described above, the service provider 104 may save this information in the venue accounts 132 in the service database 130 in step 212.

Aspects of the present technology, such as identifying locations of users on the map, and allowing discreet and private contact between those users, are implemented by the connection software 126, explained in greater detail below. The connection software may be accessed and run from the service provider 104, from a venue 150, from a user's computing device 102, or combinations thereof.

For example, in one embodiment, the connection software may remain mostly or entirely on one or more servers within the service provider 104. Users may use their computing devices 102 to access the service provider 104. One or more servers may then respond by providing the services of the present technology to locate and discreetly contact others.

As noted, the service provider 104 may be remote from, or integrated as part of, a venue 150 in different embodiments. Where the service provider 104 is remote from a venue 150, the connection software 126 may remain resident on servers in the service provider 104 as described above. Alternatively, portions or all of the connection software 126 may be embodied in a downloadable application, downloaded from the remote service provider 104 to a computing device 102 of a venue 150. For such embodiments, the connection software 126 may be downloaded to the venue in step 214 (assuming the service provider 104 is remote from the venue 150). Thereafter, users may use their computing devices 102 to access the computing device 102 at the venue to interact with the connection software and receive the services of the present technology to locate and discreetly contact others.

Portions or all of the connection software may alternatively or additionally be embodied in a downloadable application, downloaded from the service provider 104 (or venue 150) onto users' computing devices 102. In this embodiment, the connection software 126 may run entirely from a user's computing device 102, or run from the user's computing device while also accessing and receiving information/data from the service provider 104.

Each user 152 wishing to avail themselves of the connection software 126 may have their own, associated computing device 102. In embodiments, the connection software 126 is used to identify and track the position of each subscribing computing device 102 and its associated user, in real time, as the users move in and around a venue 150. Tracked computing devices may be mobile, but they may be stationary in further embodiments. As noted above, stationary computing devices 102 may more often be used by a venue by an administrator (or other) of the venue to subscribe and interact with the service provider 104, and to upload messages and a map of the venue.

In accordance with embodiments of the present technology, users 152 may subscribe to the service provider 104 to access the features of the present technology. An embodiment for subscribing to the service provider 104 will now be described with reference to the flowchart of FIG. 5. In order to subscribe, a user may contact the service provider 104 with a service access request which is received by the service provider 104 in step 222. In embodiments, a venue 150 may offer incentives, such as free or discounted food or drinks, to subscribe to the service. This access request may be made by a user using a web browser to access a webpage of the service provider 104. In further embodiments, a user may send a predefined text to a predefined telephone number associated with the service provider 104. With regard to the steps described below, it is understood that a user may perform these steps via a browser interacting with a webserver of servers 124 of service provider 104, or via text or other mail messages supported by a server 124 of service provider 104.

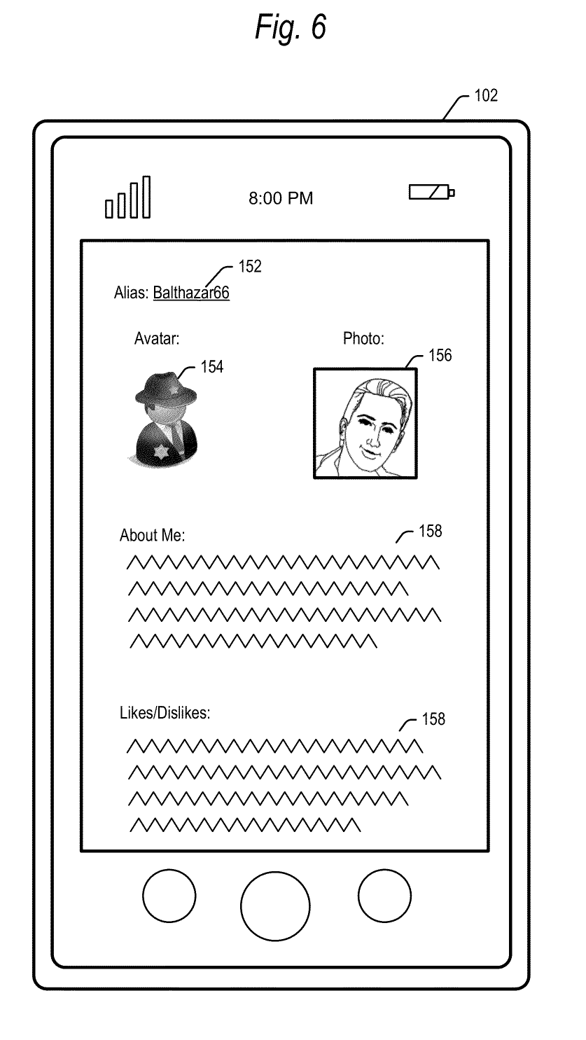

Upon prompting from the service provider 104, a user may provide registration and profile data, which is received at the service provider 104 in step 224. One example of this is shown in the illustration of FIG. 6. Using a computing device 102 (mobile or stationary), the user is prompted by the service provider 104 to provide login and profile information. For example, a user may be prompted to enter a user ID, or alias, 152. This alias (“Balthazar66” in the example of FIG. 6) may be different for each user. The user may also be requested to select a password, and an avatar 154 (from a drop-down menu of avatars or an uploaded avatar of the user's own creation). The user may also manually provide contact information such as a mobile telephone number or email. Alternatively, a user's contact information such as a mobile telephone number may automatically be uploaded to the service provider 104 upon the user contacting the service provider.

The user may also be prompted to add profile information, such as for example a photo 156, and/or a variety of textual descriptive material 158. This descriptive material 158 may for example include an “about me” section and/or a “likes/dislikes” section. Other information may be included as part of the descriptive material 158, such as for example specifics about the type of person the user might be interested in meeting (gender, age, personality, physical features, etc.). As noted above, as an alternative to the user entering profile information, the user may download this information from (or link to) an account the user has on a third-party social platform 120. Thus, when a first user accesses the profile of a second user as explained below, the second user's profile from the third-party social platform 120 may be shown to the first user.

Referring again to the flowchart of FIG. 5, once a user has provided login and profile information, the service provider 104 may assign a unique ID in step 228 linked to the user or the computing device used to subscribe to the service. In step 230, the service provider 104 may save the login information (alias and password), contact information, profile data and assigned ID to user accounts 136 in the service database 130. Once subscribed, a user may use the connection software 126 to identify the location and access the profiles of specific users at a venue.

As noted above, the connection software 126 may remain resident on the service provider 104 in embodiments. In further embodiments, once subscribed, components or all of the connection software 126 may be downloaded to and run by a subscribing user from the computing device 102 used for the subscription process in step 234.

The subscription steps described above with respect to the flowchart of FIG. 5 may be performed when a user has arrived at a venue 150. Alternatively, the subscription steps of FIG. 5 may be performed remotely from and prior to a user's arrival at a venue 150. In embodiments, a user need only set up a single account, which may then be used at all venues 150 that subscribe to the service according to the present technology. In further embodiments, a user may set up a different account for each venue that subscribes to the service according to the present technology.

The subscription steps set forth above allow a user to access the features of the connection software 126, and also allow other users to find that user and view that user's profile. However, in a further embodiment, a user may access the features of the connection software without ever going through the subscription steps of FIG. 5. In such an embodiment, a user may simply access the connection software 126, for example by sending a text to or accessing a webpage of the service provider 104 from his or her computing device. Thereafter, that user may be able to access a map including location tags of other users on his or her computing device 102 so as to be able to discreetly locate and contact one or more of those other users with his or her computing device 102 as described herein. Such a user is considered a subscribing user, but the user is not enrolled, has provided no profile information and has no logon credentials.

In an embodiment, contact information such as a mobile telephone number may be uploaded to the service provider for a non-enrolled user, upon the non-enrolled user accessing the connection software. In this instance, other users may be able to discreetly locate the non-enrolled user on their computing devices 102, but would not be able to view profile information for the non-enrolled user. In further embodiments, no contact information is uploaded for non-enrolled users. In this instance, other users may (or may not) be able to discreetly locate the non-enrolled user on their computing devices 102, but would not be able to contact the non-enrolled user.

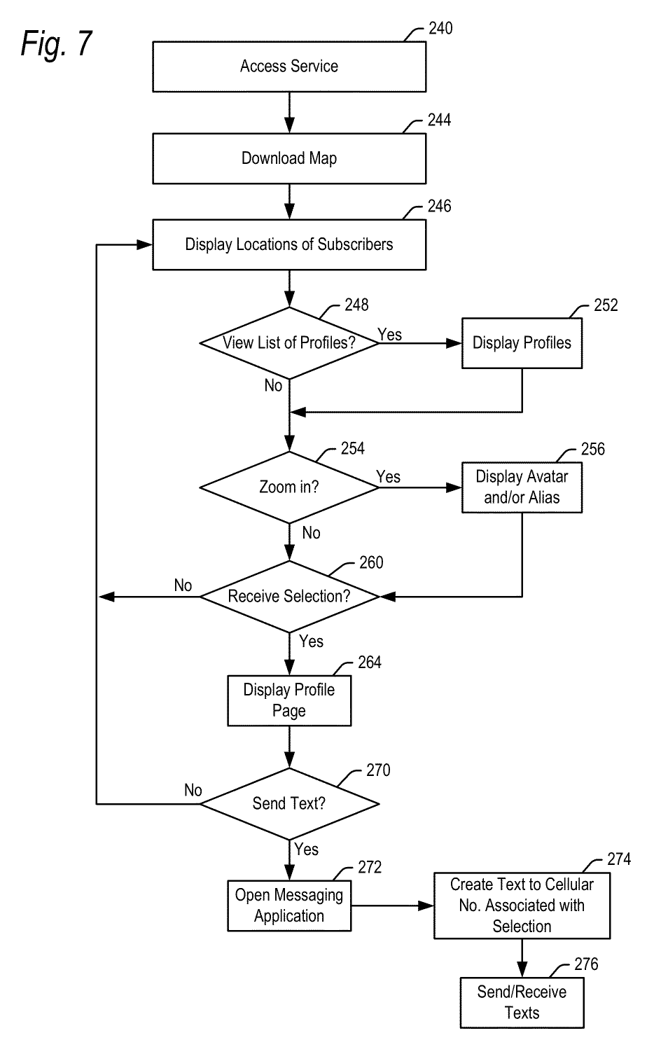

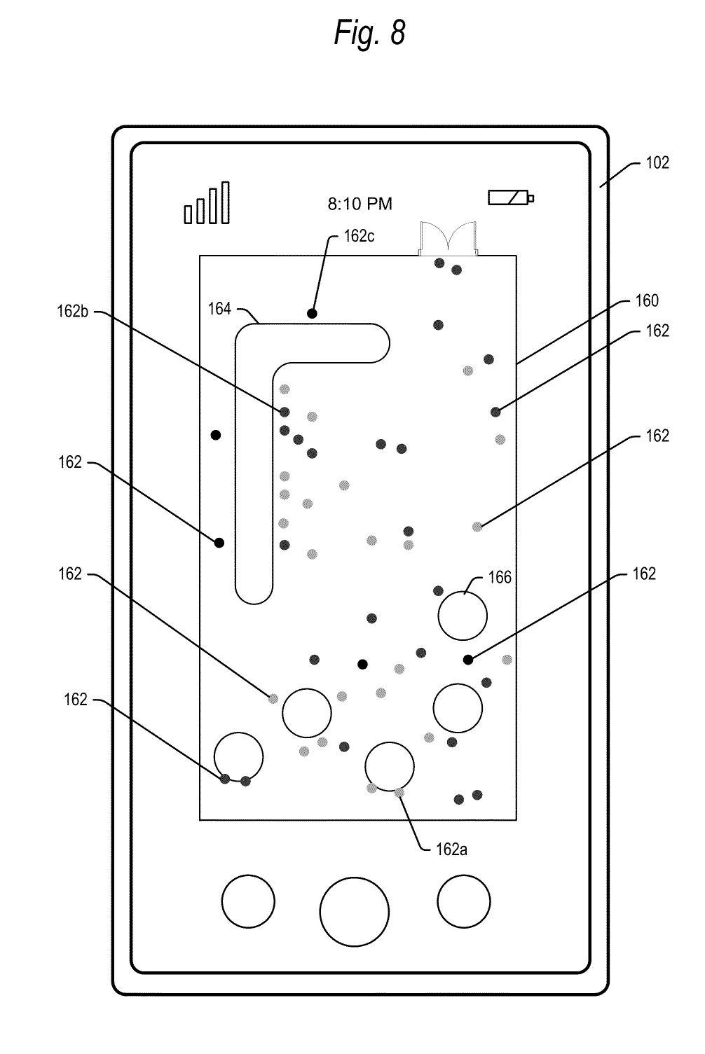

Once subscribed, a user may use the connection software 126. Once subscribed, a user's location and identity (alias and profile) may also be broadcast or otherwise made available when that user arrives a venue 150. An example of the operation of embodiments of the present technology will now be described with reference to the flowchart of FIG. 7 and the illustrations of FIGS. 8-22. In step 240, a user may access the connection software 126, which may be resident on his or her computing device 102, a computing device of a venue 150, or at service provider 104.

In embodiments, a user accesses the connection software 126 when the user arrives at a particular venue 150. In such embodiments, connection software 126 may then automatically download the map and location tags for that venue 150 in step 244. As an alternative, it is conceivable that a user may access the connection software 126 remote from any venue 150, for example while they are at home or work. When a user accesses the connection software remote from a particular venue 150, the connection software 126 may present the user with a list of venues from which the user may choose. Once a user chooses a venue, a map of the venue, together with location tags for users at that venue, may be displayed to the user. A user may choose to do this to get a real time indication of what users are at what venues 150, and to possibly locate his or her friends. It is possible that a user may select a second venue and view the map and location tags for the second venue, while the user is at a first venue.

The map may be downloaded with location tags, or location tags may be displayed on the map after the map has been downloaded (step 246). FIG. 8 is an illustration of a map 160 of the venue 150 shown in FIG. 3. The map 160 is displayed on a subscribing user's computing device 102, which in this example may be a mobile telephone, but which could alternatively be any of the computing devices discussed above.

As seen in FIG. 8, the map 160 includes boundaries (i.e., walls) and fixtures (i.e., a bar 164 and tables 166) which correlate to the real world boundaries and fixtures for the venue 150 shown in FIG. 3. FIG. 3 also shows a number of users comprised of men, women and support staff for the venue. The locations of these users may be indicated in real time on the map 160 in FIG. 8 with location tags 162 (some of which are numbered in FIG. 8).

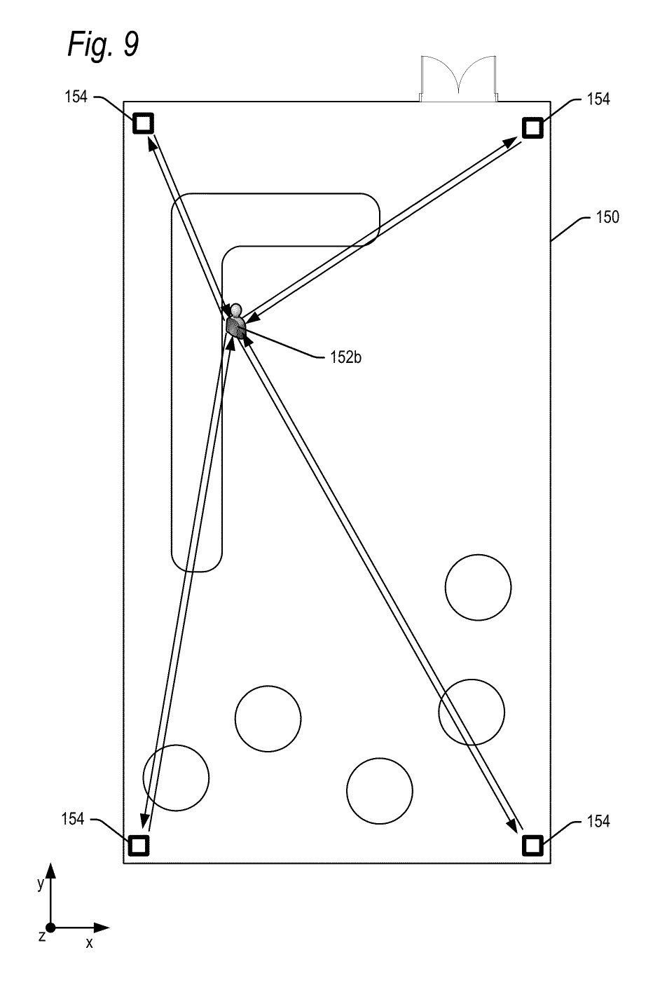

In embodiments, location tags 162 are positioned on map 160 by first determining the real world positions of subscribing users in the venue 150, and then correlating those positions to the proper positions on the rendered map. FIGS. 9-11 illustrate a few methods for determining the real-world positions of subscribing users in the venue 150. FIGS. 9-11 illustrate positional determination for a single-user 152b, but it is understood that the same operations may be performed to determine the positions of all such users.

Referring initially to FIG. 9, in one example, each of the sensors 154 may include both a transmitter and a receiver. The transmitter may emit an outbound signal which is received in the computing device 102 of user 152b. That signal may be reflected back to the receiver of the respective sensors 154, or the device 102 may otherwise respond with a signal back to the receiver of the respective sensors 154. These signals may be optical or electromagnetic, such as IR, in nature. Using the outbound and return signals received in any given sensor 154, the distance of the computing device 102, and by association the user 152b, from that given sensor may be determined. Thereafter, using the measurements from any two or more sensors 154 and various methods such as for example triangulation, the position of the user 152b may be determined in two dimensional space (along x and y axes), or three dimensional space (along x, y and z axes, with the z axis being into and out of the page of FIG. 9).

In further embodiments, the sensors 154 may comprise a light source and an image capture device such as a depth camera and, possibly, an RGB camera. In such an example, the light source may emit a light, which reflects off of the user 152b and/or the user's computing device 102, and is received back at the camera. Using known techniques such as time-of-flight, structured light, stereo image, or the like, the feedback from a single sensor 154 may be sufficient to determine the position of the user 152b in two dimensional x, y space, or three dimensional x, y, z space. The feedback from more than one sensor 154 may be used with these techniques to assist and/or confirm the position of the user 152b.

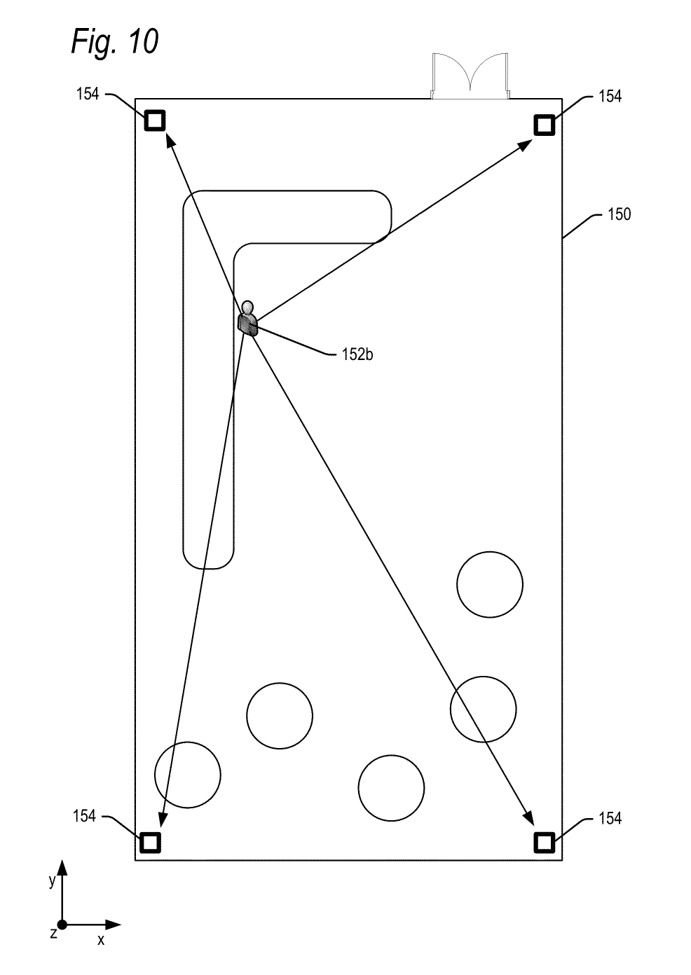

FIG. 10 illustrates an example where sensors 154 include only a receiver for receiving a signal emitted by the computing device 102 of the user 152b. Again, that signal maybe optical or electromagnetic in nature. The signal emitted from the computing device 154 may be received in the respective sensors 154 to allow determination of the distances between the computing device 102 and the respective sensors 154. Thereafter, using the measurements from any two or more sensors 154 and various methods such as for example triangulation, the position of the computing device 102, and by association the user 152b, may be determined in two dimensional space (along x and y axes), or three dimensional space (along x, y and z axes).

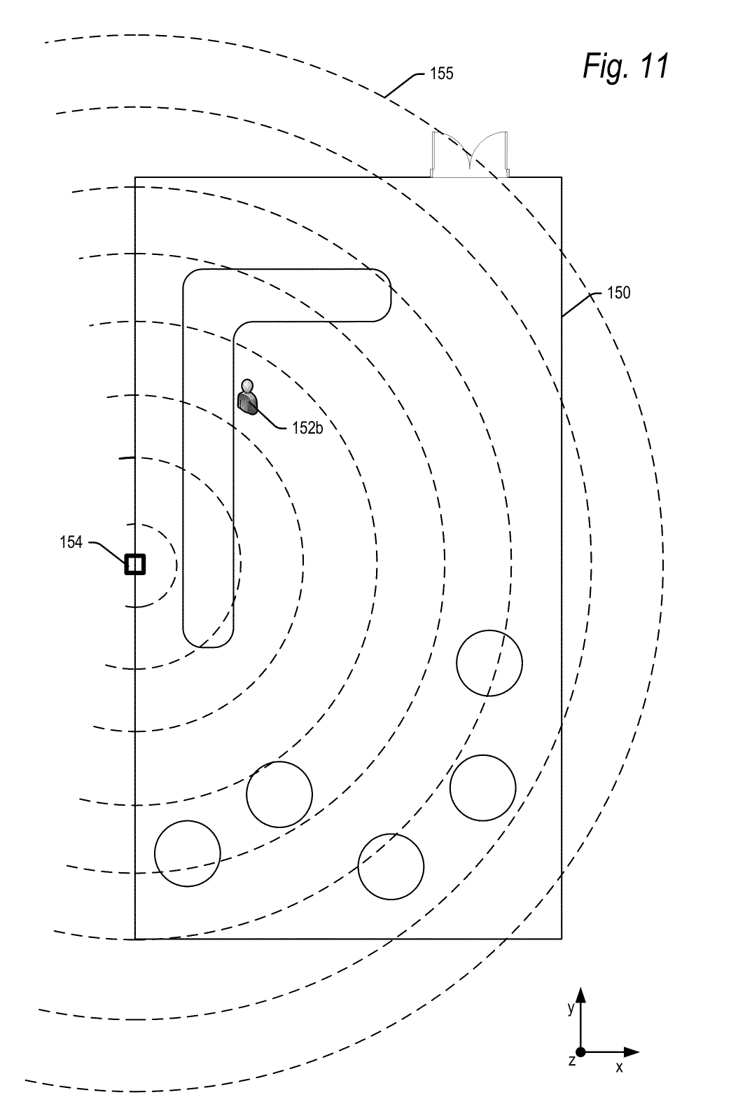

FIG. 11 illustrates an example where a single sensor 154 includes a transceiver for emitting and/or receiving a signal 155 from computing devices 102 within range of the sensor 154. The range may for example be the range of a WAN including the sensor 154. A sensor for use in this embodiment may for example be the Cisco 2700 Series Wireless Location Appliance from Cisco Systems, Inc., San Jose, Calif. Such a sensor, and other such sensors, are able to identify the location and an associated identity of wireless devices, for example as described in Chapter 13 (and other chapters) of the publication titled, “Enterprise Mobility 4.1 Design Guide,” by Cisco Systems, Inc. of San Jose, Calif. (revised Dec. 9, 2008), which publication is hereby incorporated by reference in its entirety.

It is understood that a wide variety of other technologies may be used by sensors 154 to enable the determination of the position of the device 102 and/or user 152b of that device 102 in the venue 150. Although GPS may have disadvantages as far as accuracy and working indoors, GPS may be used in further embodiments. As noted above, in embodiments, there may be as few as a single sensor 154 used in a venue 150, depending on the technology used by that sensor 154. There may be many more than four sensors used in further embodiments, depending in part on the technology used by the sensors 154 and, possibly, the size and shape of the venue 150.

Data from the sensors 154 may be uploaded to the service provider 104, which then determines the position of user 152b based on the received data. Instead of uploading to service provider 104, this data may be sent to a computing device 102 within venue 150, or to users' computing devices 102, which then determine the position of user users 152b based on the received data. Once the real world position of the user 152b is known in the venue 150, that position may be correlated to the map 160 using the registration point(s) uploaded by the venue 150 with the map 160, or other registration techniques. Once the position of the user 152b is known on the map 160, a location tag 162b for that user may be displayed on the map 160 as shown in FIG. 8.

In embodiments, it is contemplated that the service provider 104 be integrated together with the sensor 154 at or near (e.g., within wireless network range) a venue 150. Thus, a venue may have a single component which provides all of the services of the present technology to the venue 150 and users 152 at the venue 150. More than one venue may share such a single component in further embodiments.

As noted, the above-described processes may be performed for all subscribing users (enrolled and, possibly, non-enrolled users) so that the locations of all such users in the venue 150 may be represented by location tags 162 on the map 160. It may be that people at a venue do not wish to be identified and do not wish to be part of the system of the present technology. Accordingly, in embodiments, only subscribing users (enrolled and non-enrolled users who have subscribed to the service provided by service provider 104) are shown on the map 160 with location tags 162. However, it is conceivable that subscribing users and people who have not subscribed may be shown with location tags 162 on map 160.

Moreover, it may be that, at times, a subscribing user does not wish to broadcast their presence at a venue. For such instances, the connection software may offer users the option to disable its functionality for that user. The user may still be a subscriber, but his or her presence is not broadcast in this instance, and no location tag would show up for that user. When a user's functionality is disabled so that they do not show up on the map, that user may, or may not, be able to use the connection software to view profiles and locate other users in different embodiments.

Along with identifying a position of a user, the computing devices of subscribing users may also transmit the identity of the computing device. Using this and the stored login and registration data for all subscribing users, the connection software 126 knows not only the position of subscribing users 152 in the venue 150, but the identity and associated contact information (e.g., cellular telephone) of such subscribing users 152.

FIG. 8 is a high level map view of the venue 160 including location tags 162 displayed on a computing device 102. It may be too crowded if avatars and/or aliases are also displayed for each user on the computing device 102. Accordingly, in the view shown in FIG. 8, the location tags may be shown simply as dots (or any of a variety of other shapes). It is conceivable that the high level view of FIG. 8 include more detail, such as aliases and/or avatars in further embodiments. The connection software may also apply some predefined rules, such that if the spacing between location tags 162 is above some threshold, then the location tags may be displayed as avatars and/or with aliases.

The location tags 162 may be color coded to provide some information about the respective users 152, for example a first color indicating women, a second color indicating men and a third color indicating venue staff. Users or developers of the connection software 126 may define that different colors for the location tags represent different demographics in further embodiments (different age groups, single versus in a relationship, etc.).

In accordance with embodiments explained below, a first user may want to introduce him or herself to a specific second user that he/she has seen at the venue 150. However, as an alternative, a first user may simply wish to review a list of profiles for users 152 that are currently at a venue 150. In step 248, the connection software 126 determines whether a user has selected an option to view a list of profiles. This option may be presented on a graphical user interface generated by the connection software 126 on a user's computing device 102.

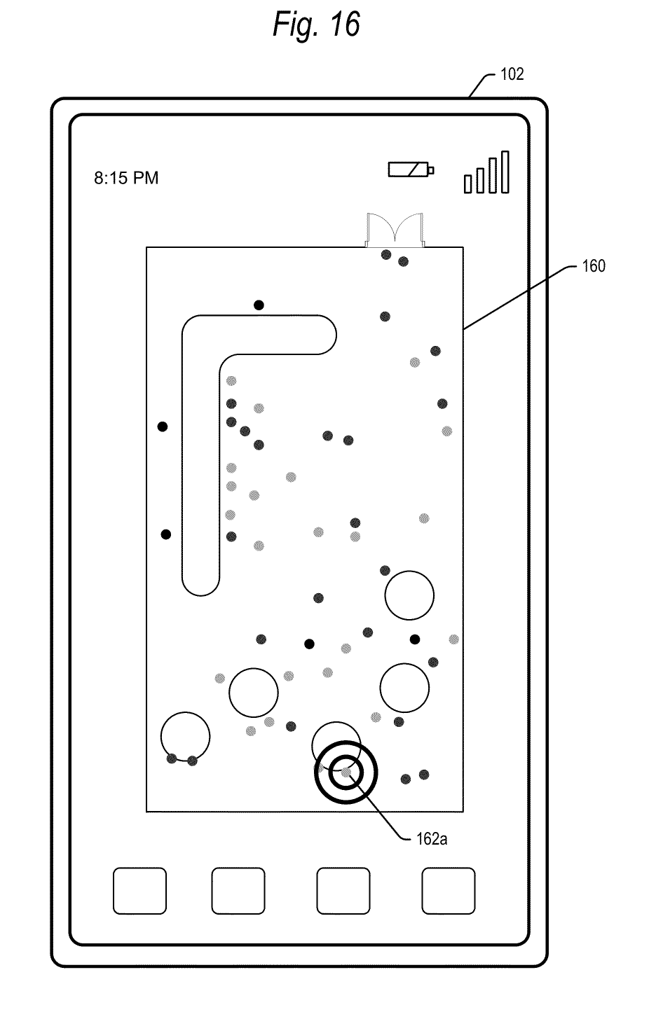

If the option to view a list of profiles is selected in step 248, the profiles of subscribing users then at the venue (or possibly recently at the venue) may be displayed to the user in step 252. The user may then peruse the profiles to possibly find friends or find someone to whom they would like to introduce him or herself as explained below. If a user finds a friend or someone else he or she would like to meet from perusing the profiles, the user may select another option on the user interface which shows the user where that selected user is in the venue. This feature is shown in greater detail below with respect to FIG. 16.

The above steps for perusing profiles may be performed by a user while at a venue. However, a user may be remote from a venue, for example at home or work, when a user performs these steps for perusing profiles. A user can select a venue and look at the profiles of users then at the venue, or who have recently been at the venue.

Instead of (or in addition to) perusing a list of profiles, a first user may see someone at the venue 150 that he or she would like an introduction to. As one example, in FIG. 3, the user 152a may want to introduce himself to the user 152b. The user 152b may be sufficiently separated from others shown on map 160 so that the user 152a may clearly correlate a location tag 162 on the map 160 on his computing device 102 with the user 152b. However, that may not be the case, for example where the user 152b is near to others shown on the map. In step 254, user may choose to zoom in on the map to gain better resolution. The user 152a may select an area of the map for enlargement, and that enlarged area may be displayed to the user 152a in step 256.

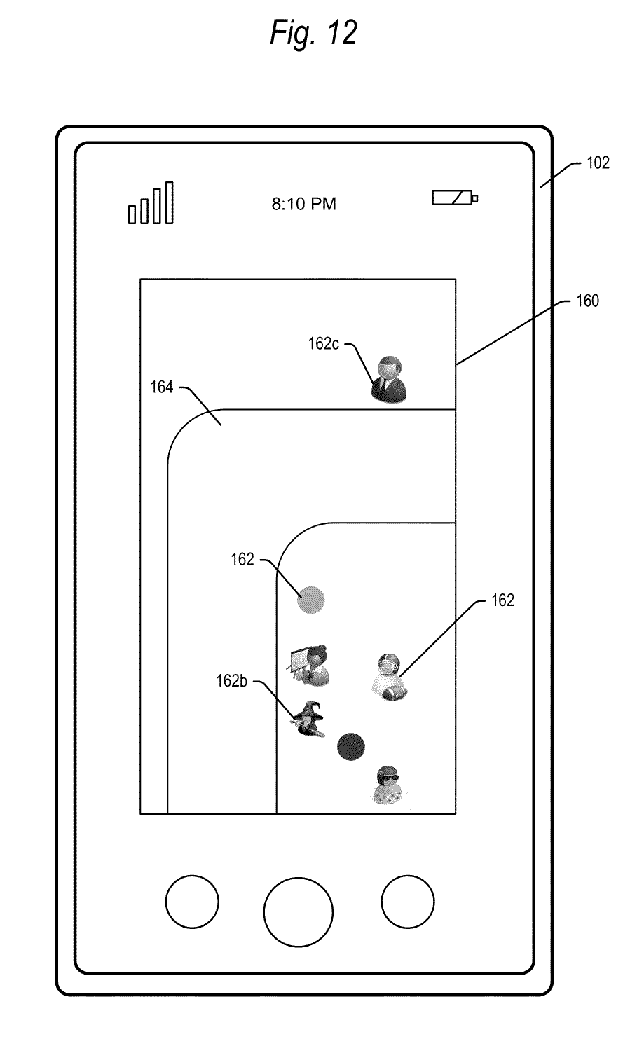

An example of a zoomed in view of map 160 is shown in FIG. 12. The magnification is large enough now that the location tags 162 may be shown to the user 152a as the avatars that the users 152 have selected for themselves. Aliases may also be shown in further embodiments. Some users may not have selected avatars, and can still be shown as dots (or other shapes). The user 152a may now have enough correlation to clearly identify which location tag 162 on the display correlates to the user 152 that he is interested in meeting.

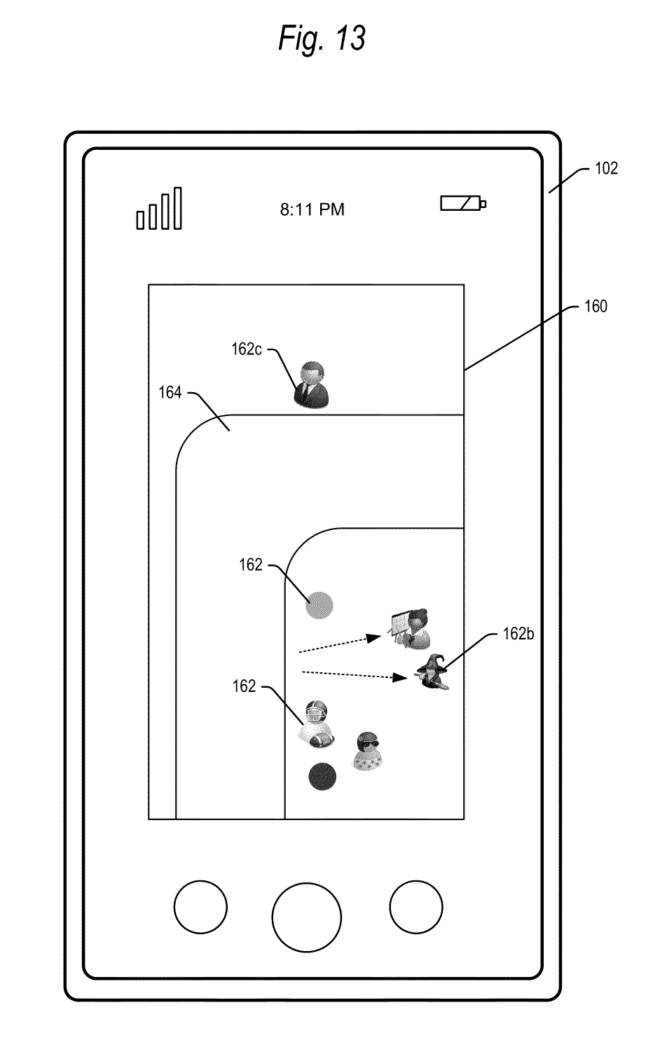

However, to gain still further clarity, the user 152a may track and correlate movements of users 152 with the movement of location tags 162 over time. As noted above, the positions of location tags 162 may be updated in real time or near real time, as users 162 move around. As such, referring to FIG. 13, if the user 152a sees the user 152b move (for example away from the bar 164), and the user also sees that the location tag 162b moves away from the bar on the map, the user can further be assured of the correlation between user 152b and the location tag 162b. In further embodiments, a venue may have video cameras set up to capture different views of the venue. A user may have an option to receive the video feed from one or more different cameras to accurately locate the real world position of other users for correlation to a location tag 162 on the map 160.

Once the user 152a has identified the location tag 162b of the user they are interested in meeting, the user 152a may select that location tag. In embodiments, each location tag may be hyperlinked to a profile page for the associated user. A user may select a specific location tag using a selection device such as for example a finger touching a selected location tag (for displays which are touch sensitive) or positioning a cursor over a selected location tag and selecting it with a mouse, keyboard or other input selection device.

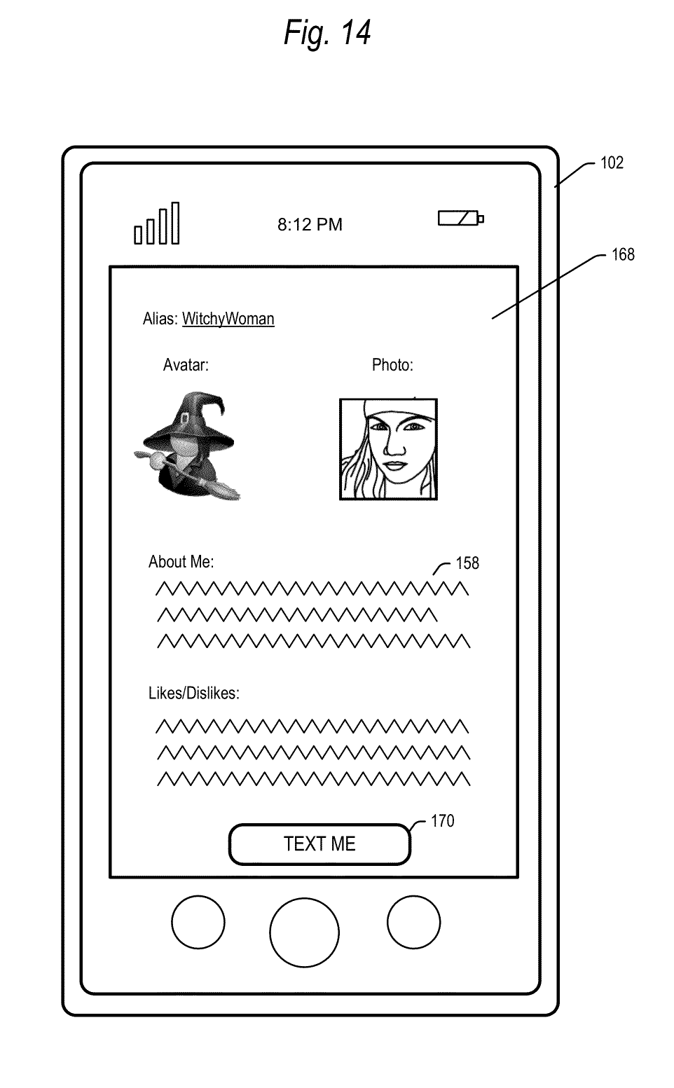

Referring again to the flowchart of FIG. 7, the location of users are associated with their information stored in database 130 (or elsewhere). If the connection software 126 receives a selection of a location tag 162 in step 260 the software 126 may display a profile page for the user associated with the selected location tag. An example of a profile page 168 is shown in FIG. 14. The profile page may include the information provided by the user 152b for his or her profile. In this case, the profile page 168 for the user 152b is for a woman having an alias “WitchyWoman.” The profile page 168 may further include a photo that the user 152b has provided. In addition to providing a likeness of the user 152b, the photo can serve to further confirm to user 152a that this is in fact the profile for the person they are interested in meeting. The profile page may further include textual descriptive material 158 as described above.

The user 152a can peruse this information. If the user 152a decides not to follow through with the introduction, the user 152a can return to a display of location tags 160 in step 246 and as shown in FIG. 8. On the other hand, if the user 152a would like to move forward with meeting the user 152b, the user 152a can then send a mail message from his computing device 102 to the computing device 102 of the user 152b in step 270. The profile page 168 may include a “text me” button 170, though the button may have different labels in further embodiments. Of note, despite that the user 152b is potentially in a crowd of people and other users, and despite that the users 152a and 152b do not know each other or have prior contact information for each other, the user 152a is able to send a message to the user 152b, and only the user 152b. As explained below, the user 152a could alternatively send to multiple recipients, but the recipients list is controlled by the user 152a.

If the user 152a elects to send a text message in step 270, the user may select the button 170, at which point a messaging application is opened in step 272 on the computing device 102 of the user 152a. The messaging application may be a text messaging application and may for example open an SMS dialog box for the user 152a to add any message that he would like to send to the computing device 102 of the user 152b.

As noted above, the user 152a may not know the user 152b and may have no contact information for the user 152b (though in further embodiments, the user 152a may know and have contact information for the user 152b). When a request is received to send a communication to user 152b, contact information for user 152b is retrieved from the database, and the message is automatically addressed to the computing device 102 of the user 152b. For example, if sending a text message, the message is automatically addressed to the mobile telephone number received for the user 152b in setting up her profile. In further embodiments, the messaging application may be an email application, in which case the message may be automatically addressed to an email address provided by the user 152b in setting up her profile. In further embodiments, the contact information provided by user 152b may instead by an account on a social networking website, such as Facebook® or Twitter®. In such event, the user 152a may post a note to the account user 152b has on that social networking website.

In embodiments where the user 152a is sending a text or email, the user 152a may be able to see the telephone number, email address or other contact information of user 152b. However, for security or other reasons, users may not wish to give out their contact information such as mobile telephone number or email address in the use of the present system. Accordingly, in the above-described scenario, in further embodiments, the user 152a is not able to see or identify the telephone number, email address or other contact information of the user 152b. In embodiments, users may configure their profiles as to whether other users are able to see, or not see, contact information.

For additional security, in further embodiments, the message to be sent by the user 152a may in fact be addressed to a proxy address (proxy telephone number or proxy email address) for example at the service provider 104. In this instance, after the user 152a creates and sends the message, the message may be sent to the service provider 104, which may then resolve the proxy address to the correct address, and then forward the message to the user 152b. Thus, the user 152a is able to send a message to the user 152b, but does not in fact have the actual contact information for the user 152b. It is conceivable that proxy addresses not be used, and messages be sent directly to the actual contact information in further embodiments. In further embodiments, a venue 150 may give out computing devices 102 to users for temporary use while at the venue.

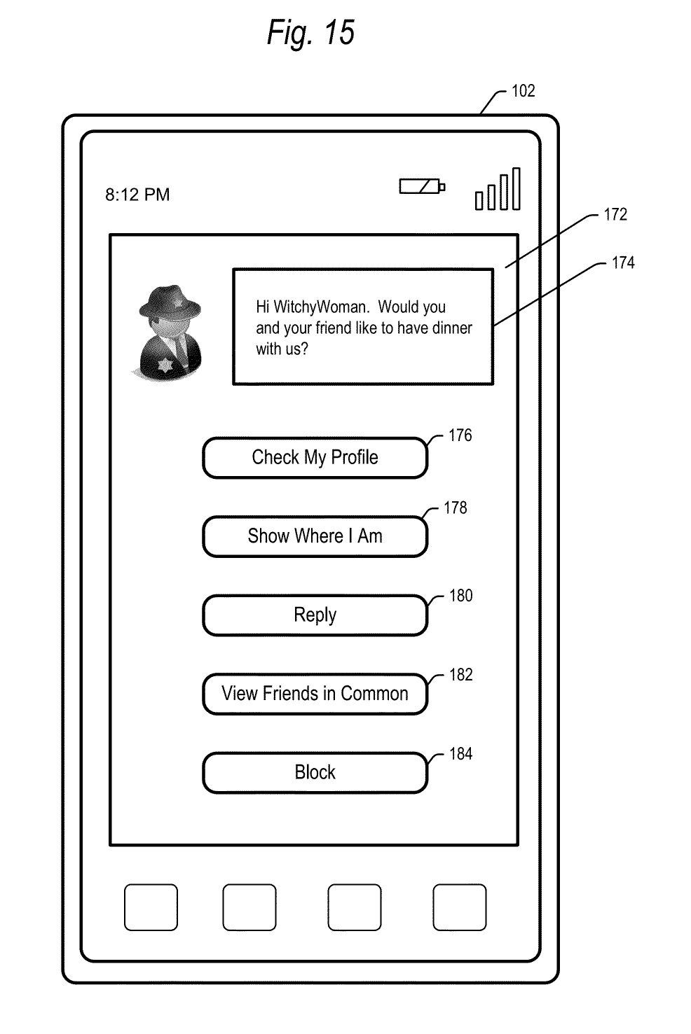

FIG. 15 illustrates the computing device 102 of the user 152b, and shows a message page 172 with the message 174 received from the user 152a. For example, the user 152a may send a message, “Hi WitchyWoman. Would you and your friend like to have dinner with us?” The message 174 shown is by way of example, and as indicated above, may be any message that the user 152a wishes to send. The message page 172 may also have a number of buttons for possible actions that the user 152b may take in response to the received message 174. For example, the message page 172 may also include a “check my profile” button 176, though the button 176 may have different labels in further embodiments. The connection software 126 has the identification information of the user that sent a message, and if the user 152b selects the button 176, the profile page for the user 152a may be displayed to the user 152b.

The message page 172 may further include a “show where I am” button 178, though the button 178 may have different labels in further embodiments. Again, the connection software 126 has identification information of the user that sent a message, including where that user 152a is in the venue 150. If the user 152b selects the button 178, a map of the venue 150 may be displayed to the user 152b with the location tag 162a of the user 152a highlighted as shown in FIG. 16. In this instance, the location tag 162a may be highlighted in a variety of different ways.

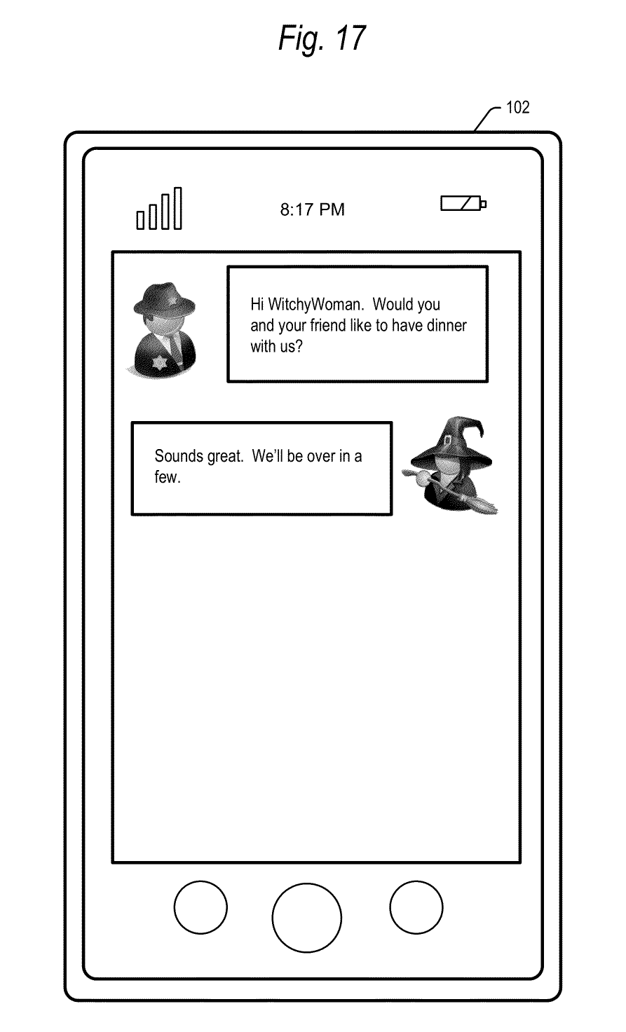

The message page 172 may further include a reply button 180. The user 152b may select the reply button 180, to initiate a dialogue with the user 152a (step 276) and they can thereafter exchange messages using the messaging applications on their respective computing devices 102 as shown for example in FIG. 17. For example, user 152b may reply to the message from user 152a, “Sounds great. We'll be over in few.” This reply is by way of example and can be any reply the user 152b chooses to make. A reply made by the user 152b may be to a proxy address in service provider 104, which may be resolved into the real contact address for user 152a by the service provider 104. Alternatively, the reply may be directly to the real contact address for the user 152a.

Referring again to FIG. 15, the message page 172 may further include a “view friends in common” button 182, though the button 182 may have different labels in further embodiments. As noted above, the service provider 104 may store friends of the different users, and may cross-reference users' friends lists to identify friends in common. Thus, if the user 152b selects button 182, the connection software 126 may display a new page including any friends that users 152a and 152b share in common. User 152b can at that point contact a mutual friend to inquire about user 152a. The connection software 126 may also provide this as an option to the user 152a before the user 152a elects to contact the user 152b.

The message page 172 may further include a “block” button 184, though the button 184 may have different labels in further embodiments. If the user 152b selects button 184, a message may be sent to the service provider 104 to block all communications from user 152a to user 152b. The service provider 104 may store this as a rule in association with the account data of user 152a and/or user 152b. Thereafter, if user 152a attempts to send a message to user 152b, the message is not sent to user 152b. User 152a may or may not receive notification of a blocked message in different embodiments of the present technology.

The user 152b may select one or more of the options described above. The buttons 176, 178, 180, 182 and 184 are merely examples of options which may be provided to the user 152b on message page 172. It is understood that one or more of these buttons may be omitted, rearranged in a different order, or supplemented with other options in further embodiments.

In embodiments described above, a first user may identify a second user and use the map 160 to initiate a dialog, while at the venue. However, it is conceivable that the same process takes place while the first user is remote from a venue (or remote from all venues, for example at home). While remote, the first user may pull up a list of maps as described above, peruse the maps to see who is at what venues, select a user from a map at a given venue, and then initiate the dialogue with the selected user as described above. It is not required that the first and second users be at the same venue at the same time in order to initiate a dialogue according to the present technology.

In general, the connection software 126, as implemented by one or more servers at the service provider 104, and/or computing devices 102 of the venue or users, provides a variety of functions. These functions include, but are not limited to:
allowing venues and users to sign-up for and subscribe to receive the services;
storing and downloading maps of different venues;
receiving data from sensors at a venue and determining the location and identity of computing devices and/or users from that data;
registering the determined location of computing devices and/or users on the map of the venue;
allowing users to select one or more location tags from a displayed map; and
displaying profile information for a user associated with a selected location tag, and
initiating a discreet dialog with the user associated with a selected location tag.

Using this functionality, embodiments of the present technology enhance social interactions by allowing new introductions to be made in a discreet and private manner. A first user has the ability to identify a second user that he or she would like to send a message to. Thereafter, even though the first and second users have no pre-knowledge of each other's identity or contact information, the first user is able to send a private message specifically to the second user, and the second user alone. In further embodiments, instead of not knowing a message recipient, the present technology may be used by friends who know each other to locate and contact each other at a venue.

In still further embodiments, the present technology may be used by the venue 150 to send out an announcement to a select group or all subscribers, or periodic announcements to a select group or all subscribers. The announcements may relate to discounts, specials, events, etc., and may be targeted for specific demographics based on information in user profiles. Additionally, the venue may keep track of users' ordering preferences, for example storing the data in the service database 130 of service provider 104. Thus, a venue can target messages to specific users. For example, if some users have shown a preference for a specific type of alcohol, and the venue is going to have a special featuring that alcohol, the venue can target messages to those specific users in advance.

Embodiments of the present technology described above provide merely some examples, and a wide variety of other use scenarios are contemplated for the present technology. Continuing with an example where venue 150 is a bar or restaurant, a first user may see a bartender or waiter (for whom profiles have also been created in the database), find them on the map 160 (i.e., location tag 152c in FIGS. 8 and 12), and send them a message.

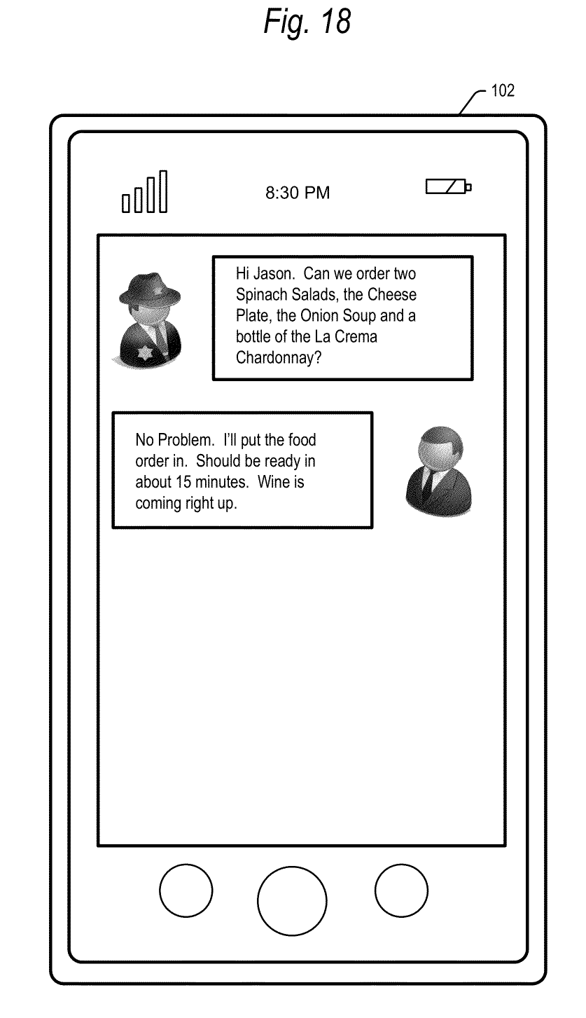

An example of this message exchange is shown in FIG. 18, where a user is able to order dinner and/or drinks from a waiter without having to leave his or her seat. In this example, the patron may send a message, “Hi Jason. Can we order two Spinach Salads, the Cheese Plate, the Onion Soup and a bottle of the La Crema Chardonnay?” To which, the staff person may reply, “No Problem. I'll put the food order in. Should be ready in about 15 minutes. Wine is coming right up.” This exchange is by way of example only and can be any exchange the patron and staff person care to provide.

As a further embodiment, a user may provide his or her credit card information to the service provider 104, for example as part of the user's profile information. When the user thereafter orders food or beverage (either as shown in FIG. 18 or by the user approaching a waiter), the waiter can identify that user, and can automatically charge the ordered food/beverage to that user's credit card. This can also be used in a store, when a user wishes to purchase goods. A user can identify an item to be purchased, for example by its SKU number, and enter that number in his or her computing device. Thereafter, the store can identify where that user is, access their credit card number, and charge the card to complete the purchase.

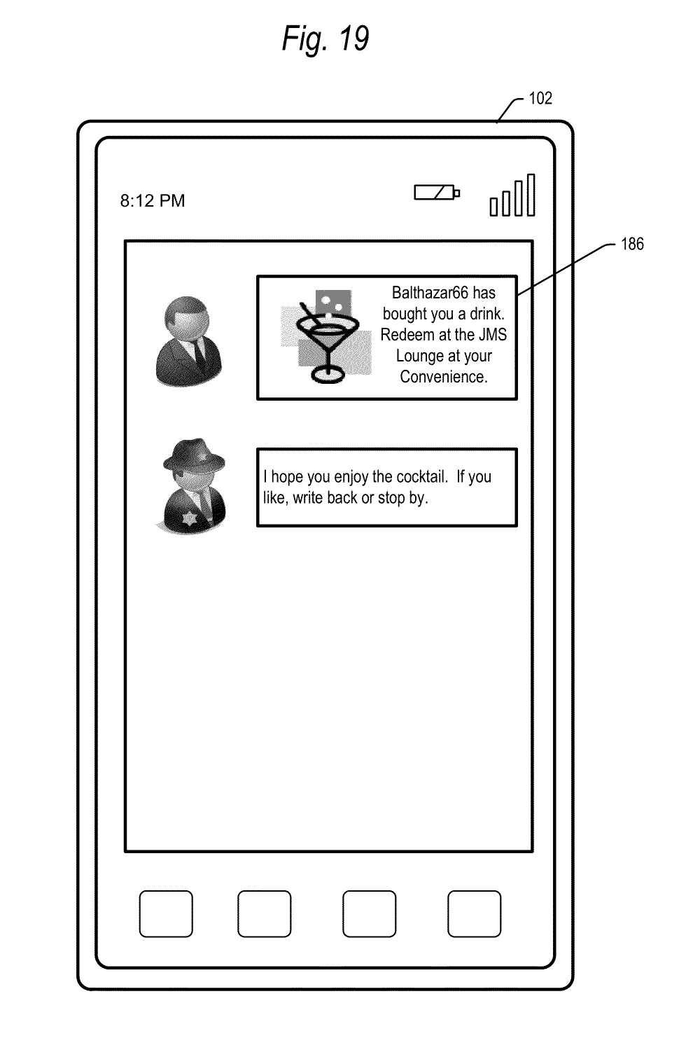

FIG. 19 illustrates a further use scenario. In this embodiment, a user such as user 152a may contact a staff person 162c to indicate that the user 152a wishes to send a coupon 186 for a specified dollar amount or for one or more food items/beverages to a specified user that the user 152a identified using the map 160 and location tags 162. The coupon may be charged to the credit card of the user 152a. Thereafter, the venue 160 may send a coupon 186 to the specified user, redeemable at that venue. The coupon may for example set forth, “Balthazar66 has bought you a drink. Redeem at the JMS Lounge at your Convenience.” The coupon could include a wide variety of text in further examples. The user 152a may thereafter follow up with a message as shown in FIG. 19 and as described above, for example, “I hope you enjoy the cocktail. If you like, write back or stop by.” The message may be any of a variety of other messages in further examples. If the user 152a is blocked from contacting the specified user, the message from the user 152a may be blocked, and, possibly, the coupon 186 would be blocked as well.

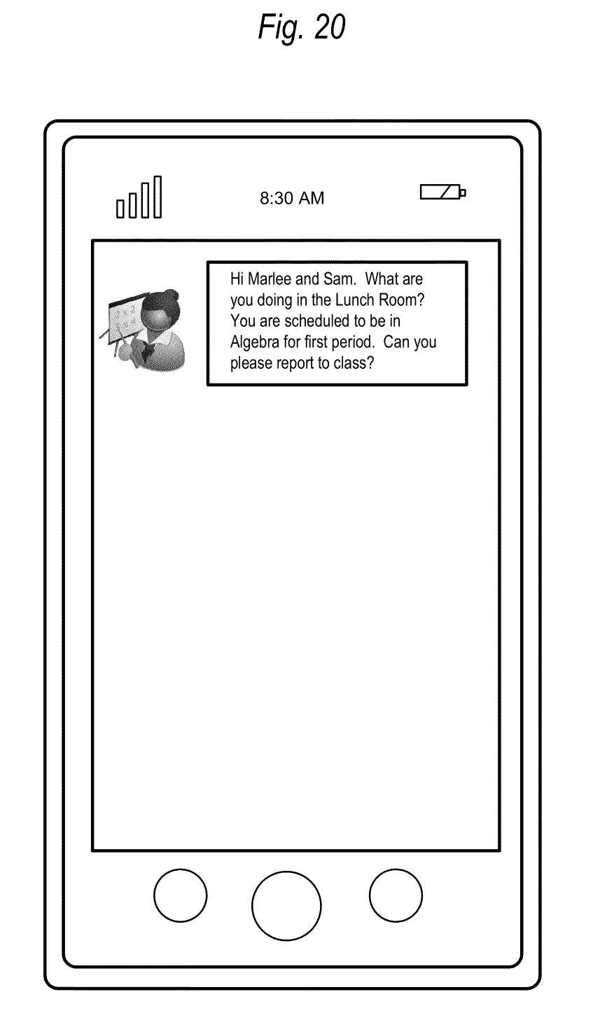

Referring to a further use scenario shown in FIG. 20, students at a school may have profiles and be subscribed to the system according to the present technology. Teachers and school administrators may thereafter track the whereabouts of different students. Thus, where one or more students are not in their class at the appointed time (or otherwise wish to send a message to students), the teachers and/or school administrators can find out where they are, and send them a message to get class. For example, a teach or administrator may send a message, “Hi Marlee and Sam. What are you doing in the Lunch Room? You are scheduled to be in Algebra for first period. Can you please report to class?” This is by way of example only. This use scenario may be generalized to other scenarios so that a first user may locate and contact a second user, for example to keep the second user on schedule and at the right place at the right time.

In FIG. 20, the message generated was sent to two recipients (Marlee and Sam). In embodiments described above, a first user is able to locate and send a message to a second user. However, in any of the above-described embodiments, a first user may locate and send a message to two or more other users. That is, the message would be sent to multiple recipients at the same time. In an example, a user may have the option of selecting multiple location tags 162, so that each would be a recipient of a given message.

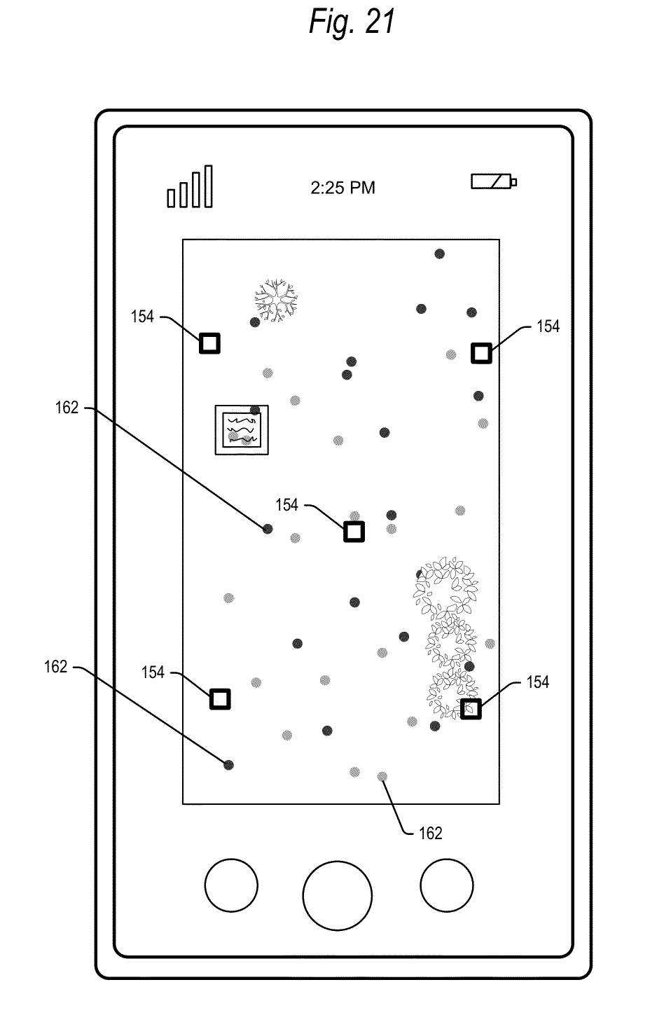

As noted above, any of a wide variety of venues may be mapped and used in accordance with the present invention. FIG. 8 illustrates an indoor venue. FIG. 21 illustrates a further embodiment where the venue 150 is an outdoor venue, such as for example a park. In this embodiment, a map 160 of the park may be created and uploaded to service provider 104, and thereafter users may access the map 160, together with location tags 162 of other subscribing users in the outdoor venue 150. As shown, sensors 154 may be positioned in the outdoor venue to identify the location of users in the outdoor venue. As noted above, GPS can be used as an alternative to the sensors 154.

In embodiments described above, a venue generates a map which then aids users in correlating other users in the real-world space of the venue with location tags shown on the map. However, in a further embodiment, it is conceivable that the present technology operate without a map. One such embodiment is shown in FIG. 22. This embodiment illustrates a computing device of a user such as user 152a, and a number of other users who have subscribed to the service. Using sensors 154 or other technologies, the location tags 162 of other users relative to the location tag 162a of the user 152a may be shown on the computing device 102 of the user 152a. The user 152a may locate a second user, correlate the position of the second user with a location tag 162 on the computing device 102, and thereafter introduce themselves to the second user as described above. Thus, for example, a first user may be walking down a street (which is outfitted with sensors 154 or other technologies) and introduce themselves to a second user that they see.

Records of use of the present technology may be stored in service provider 104. These records may be kept confidential or made public. Where public, the connection software 126 may provide an option on a user interface for users to view these public records. The public records may show for example how often given users have used the system to contact others. The public records may also show for example how often given users have been contacted by others via the system. Information provided by different users 152 may also be collected and mined by the venue 150 and/or service provider 104, for example for the purposes of targeted advertising.

The present system may also have further tie-ins to one or more of the third party social platforms 120 (FIG. 1). For example, as noted above, initial contacts and subsequent dialogue between users may be hosted on Facebook®, Twitter® or other social platforms. These social platforms 120 may also be integrated into the present system so that exchanged texts between first and second users also use content from these third-party social platforms.

FIG. 23 illustrates details of a computing environment 300, which may be a sample computing device 102, or server as described herein, for implementing aspects of the present technology. Components of computing environment 300 may include, but are not limited to, a processor 302, a system memory 304, storage media 306, various system interfaces and a system bus 308 that couples various system components. The system bus 308 may be any of several types of bus structures including a memory bus or memory controller, a peripheral bus, and a local bus using any of a variety of bus architectures.

The computing environment 300 further includes computer readable media. Computer readable media can be any available tangible media that can be accessed by the computing environment 300 and includes both volatile and nonvolatile media, removable and non-removable media. Computer readable media does not include transitory, modulated or other transmitted data signals that are not contained in a tangible media. The system memory 304 includes computer readable media in the form of volatile and/or nonvolatile memory such as ROM 310 and RAM 312. RAM 312 may contain an operating system 313 for computing environment 300. The computer readable media may also include storage media 306, such as hard drives, optical drives and flash drives.

The computing environment 300 may include a variety of interfaces for the input and output of data and information. Input interface 316 may receive data from different sources including touch (in the case of a touch sensitive screen, a mouse 324 and/or keyboard 322.

A video interface 330 may be provided for interfacing with a touchscreen 331 and/or monitor 332. A peripheral interface 336 may be provided for supporting peripheral devices, including for example a printer 338.

The computing environment 300 may operate in a networked environment via a network interface 340 using logical connections to one or more remote computers 344, 346. The logical connection to computer 344 may be a local area connection (LAN) 348, and the logical connection to computer 346 may be via the Internet 350. Other types of networked connections are possible, including broadband communications as described above.

It is understood that the above description of computing environment 300 is by way of example only, and may include a wide variety of other components in addition to or instead of those described above.

In summary, one example, the present technology relates to a method of enabling a first user to contact a second user at a venue, comprising: (a) displaying location tags on a computing device of the first user, the location tags representing positions of users in the venue; (b) receiving a selection by the first user of a location tag, the selected location tag correlated to a position of the second user in the venue; and (c) opening a message for sending by the first user after receipt of selection of the second user in said step (b), the message addressed for receipt by the second user.

In another example, the present technology relates to a system of enabling introductions, comprising: a digitally encoded map of a venue; and a processor on a computing device, the processor executing an connection software to cause the computing device to display the digitally encoded map and a location tag correlating to a location of a user at the venue, the processor further causing information regarding the user to be displayed on the computing device upon receipt of a selection of the location tag.

In a further example, the present technology relates to a computer readable medium for programming a processor to perform a method of enabling introduction of a first user to a second user, the method comprising: (a) displaying a map of a venue on a first computing device of the first user; (b) displaying location tags on the first computing device, the location tags representing users in the venue, and the location tags showing positions of users in the venue; (c) receiving a selection by the first user of a location tag based on the first user determining the selected location tag correlates to the second user; and (d) displaying information to the first user for the user represented by the selected location tag.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1. A method of establishing communication between two or more users, comprising:
(a) storing information regarding a first user, the information including contact information for the first user;
(b) displaying, on a computing device of a second user, a map of a venue where the first and second users are located, the map displayed on the computing device of the second user registered by at least one registration point to the venue, registering of the map by at least one registration point comprising the step of identifying in real world coordinates at least one point in the venue, and correlating the real world coordinate to a depiction of the at least one point on the map of the venue, and the map displaying representations of a plurality of users including the first and second users, the map updating positions of the representations of the plurality of users in real time as positions of the plurality of users change in the venue;
(c) disambiguating, on the computing device of the second user, which representation represents the first user by at least one of:
(i) correlating movements of one or more representations on the map in real time with movements of the first user in the venue, and
(ii) displaying a photograph of a user upon selecting a representation;
(d) once disambiguated, receiving, from the computing device of the second user, a request to contact the first user, the second user having no contact information for the first user;
(e) retrieving the contact information for the first user stored in said step (a); and
(f) sending a communication from the computing device of the second user to a computing device of the first user using the contact information retrieved in said step (e).

2. (canceled)

3. The method of claim 1, further comprising a step of associating the information stored in said step (a) with the representation of the first user.

4. (canceled)

5. The method of claim 1, said step (d) of receiving a request to contact the first user, comprising receiving selection on the map of the representation of the first user.

6. A method of establishing communication between two or more individuals, comprising:
(a) maintaining a database in which locations of users are associated with contact information of the users;
(b) receiving a request from a second user to communicate with a first user, where the request to communicate includes an indication of the location of the first user but does not include contact information of the first user;
(c) determining the contact information of the first user from the association with the location of the first user;
(d) sending a communication to the first user, using the contact information of the first user, indicating that the second user wants to communicate with the first user; and
(c) providing an option for the first user to block the second user from contacting the first user.

7. The method of claim 6, further comprising a step of displaying a location tag on a computing device of the second user, the location tag correlating in real time to the location of the first user.

8. The method of claim 7, said step (b) of receiving a request from a second user to communicate with a first user comprises a step of receiving selection of the location tag on the computing device of the second user.

9. The method of claim 8, further comprising a step of correlating the location tag as being associated with the first user prior to selection of the location tag.

10. The method of claim 9, said step of correlating the location tag comprising a step of zooming in the display to provide greater resolution of the location tag relative to other displayed location tags.

11. The method of claim 9, said step of correlating the location tag comprising a step of tracking movement of the first user in real world space, tracking movement of the location tag and correlating the movement of the first user in real world space with the movement of the location tag.

12. The method of claim 8, further comprising a step of correlating the location tag as being associated with the first user by displaying a photograph of the first user upon selection of the location tag.

13. The method of claim 6, further comprising a step of storing profile information for the first user in the database maintained in said step (a).

14. The method of claim 13, said step of storing profile information for the first user in the database comprising a step of storing an avatar for the first user, a photo of the first user, biographical information on the first user and/or a description of things the first user likes and does not like.

15. The method of claim 14, further comprising a step of displaying the profile information for the first user to the second user before receiving a request from the second user to communicate with the first user.

16. A method of establishing communication between two or more individuals at a venue, comprising:
(a) storing information regarding a first user, the information including contact information for the first user;
(b) storing a map of the venue;
(c) displaying, on a computing device of a second user, the map of the venue and an identifier on the map indicating a location of the first user at the venue, the identifier linked to the information stored in said step (a) regarding the first user;
(d) receiving, from the computing device of the second user, selection of the identifier displayed in said step (c);
(e) sending a communication from the computing device of the second user to a computing device of the first user using the contact information stored in said step (a); and
(f) receiving, on a user interface of the computing device of the first user, an indication of the communication sent in said step (e), said user interface further displaying options to:
(i) check a profile of the second user;
(ii) display a map highlighting a position of the second user;
(iii) reply to the second user;
(iv) view stored information regarding friends in common between the first and second users; and
(v) block contact by the second user, including blocking the display of the second user from showing the first user.

17. The method of claim 16, further comprising a step of correlating a location of the identifier displayed on the map to a location of the first user in the venue prior to receiving selection of the identifier in said step (d).

18. The method of claim 17, said step of correlating the location of the identifier comprising a step of zooming in the display to provide greater resolution of the identifier relative to other displayed identifiers.

19. The method of claim 17, said step of correlating the location of the identifier comprising a step of tracking movement of the first user in real world space, tracking movement of the identifier and correlating the movement of the first user in real world space with the movement of the identifier.

20. The method of claim 16, wherein the identifier comprises a first identifier, the method further comprising a step of displaying, on the computing device of the first user, the map of the venue and a second identifier on the map indicating a location of the second user at a venue after said step (e), the second identifier linked to information stored regarding the second user.

21. The method of claim 20, further comprising a step of displaying, on the computing device of the first user, biographical information for the second user after said step (e).

22. The method of claim 16, wherein said step (a) further comprises a step of storing biographical information of the first user, the method further comprising a step of displaying the biographical information for the first user on the computing device of the second user after said step (d) of receiving selection of the displayed identifier.

23. A system of enabling introductions, comprising:
a digitally encoded map of a venue;
a sensor for sensing location of users in the venue; and
a processor on a computing device, the processor executing software to cause the computing device to display the digitally encoded map and a location tag correlating to a location of a user at the venue sensed from the sensor, the processor further causing information regarding the user to be displayed on the computing device upon receipt of a selection of the location tag.

24. The system of claim 23, further comprising a communications protocol for initiating an electronic communication from the computing device to the user.

25. The system of claim 23, the processor further updating the displayed location of the user on the map of the venue in real time as the user moves.
